(19) United States
(12) Patent Application Publication
(10) Pub. No.: US 2009/0144999 A1
(43) Pub. Date: Jun. 11, 2009

(54) INTERIOR CONTOUR MEASUREMENT PROBE

(76) Inventor: Kam C. Lau, Potomac, MD (US)

Correspondence Address: Kam C. Lau, 15000 Johns Hopkins Drive, Rockville, MD, 20850, US

(21) Appl. No.: 11/947,453

(22) Filed: Nov. 29, 2007

Related U.S. Application Data
(60) Provisional application No. 60/861,875, filed on Nov. 30, 2006.

(51) Int. Cl. G01B 5/20

(52) U.S. Cl. 33/544.1

(57) ABSTRACT

A device for measuring an interior contour of a hollow object has a probe bar of known length mounted within a ball that pivots within a circular bearing mounted on a base plate. The base plate is mounted on the object above an external hole into the interior of the object with the lower end of the probe bar protruding into the interior of the object. The upper end of the probe bar is moved until the lower end of the probe bar contacts the interior surface of the object, then the upper end of the probe is moved further to cause the lower end to pass across the surface of the interior of the object. A laser tracker tracks a laser target mounted on the upper end of the probe bar, calculating the position of the lower end and the contour of the interior surface from the position of the laser target and known bar dimension data.

### CROSS-REFERENCES TO RELATED APPLICATIONS

This application is related to U.S. Pat. No. 4,714,339, entitled “Three and Five Axis Laser Tracking Systems” and issued Dec. 22, 1987; U.S. Pat. No. 6,049,377, entitled “Five-Axis/Six-Axis Laser Measuring System” and issued Apr. 11, 2000; U.S. Pat. App. Pub. No. US 2003/0043362 A1, entitled “Six Dimensional Laser Tracking System and Method” and published Mar. 6, 2003; U.S. Pat. App. Pub. No. US 2003/020685 A1, entitled “Nine Dimensional Laser Tracking System and Method” and published Nov. 6, 2003. This application hereby incorporates by reference all above-referenced patents and patent applications in their entirety.

### BACKGROUND

As described in the references cited above, an optical measuring system utilizing the coherent, monochromatic output of a low-intensity laser can provide an efficient and adaptable means for measuring the position, orientation, and external dimensions of an object. However, partially enclosed surfaces within objects, such as the interior of a cylinder, may not be directly accessible to known measuring systems and may therefore be difficult to measure accurately with an optical measuring system.

### SUMMARY

The measurement probe disclosed hereinafter provides means for measuring the internal dimensions of certain hollow objects with known optical measuring systems. A probe bar is pivotally mounted on a base plate. The probe bar has a retroreflector mounted on its upper end and a tooling ball mounted on its lower end. The lower end of the probe bar is inserted into the open end of a cylinder until the base plate rests against the open end of the cylinder. A laser tracker acquires the retroreflector. The probe bar is moved in a circle with the tooling ball remaining in contact with the inner surface of the cylinder. The laser tracker tracks the retroreflector, thereby measuring the inner dimensions of the cylinder.

### BRIEF DESCRIPTION OF THE DRAWINGS

FIG. 1 shows a cross-sectional elevation view of a measurement probe.

FIG. 2 shows a cross-sectional elevation view of a spherical mounted retroreflector.

FIG. 3 shows an enlarged cross-sectional elevation view of the ball, center of the probe bar, circular bearing, and nearby supporting structures.

### DETAILED DESCRIPTION

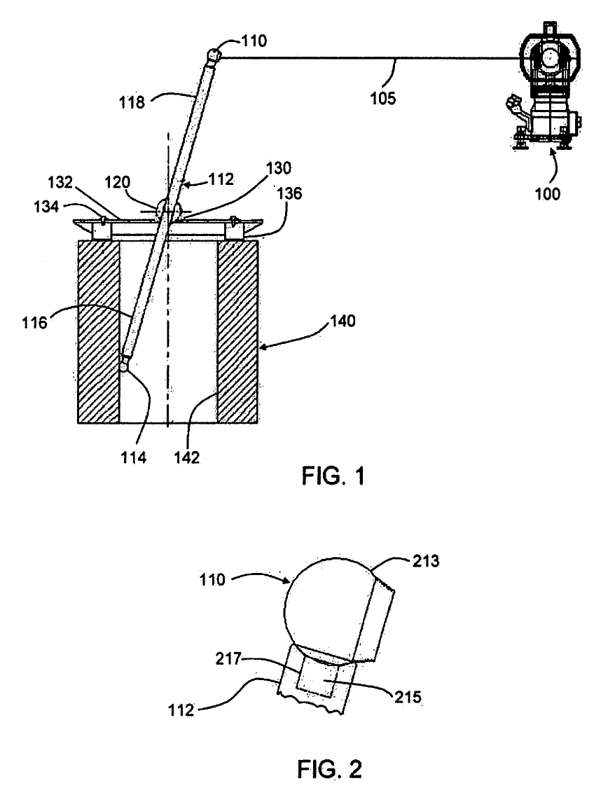

The measurement probe disclosed below provides means for quickly and accurately measuring the inner diameter and shape of a cylinder with a laser tracker. FIG. 1 shows a cross-sectional elevation view of a measurement probe. A laser tracker 100 emits a laser beam 105 that impinges on a spherical mounted retroreflector (SMR) 110. The SMR 110 is attached to a probe bar 112 of known length that passes through a ball 120 and a base plate 132, terminating in a probe tip 114. The ball 120 rests upon a circular bearing 130 affixed to the upper or lower surface of the base plate 132. The base plate 132 is supported by magnetic feet 136 attached to the base plate 132 by machine screws 134 or other fasteners known in the art. The magnetic feet 136 form a magnetic attachment to a work piece, in this case a cylinder 140 with an inner surface 142 to be measured.

In this embodiment, the laser tracker 100 is a LASER TRACKER II PLUS!™ manufactured by Automated Precision Inc. of Rockville, Md., USA. Generally, a suitable tracking device must be able to locate a target within three spatial dimensions with a high degree of accuracy. The target must be small enough to be handled easily and mounted upon the probe bar 112.

The laser tracker 100 is especially suitable for rapid, accurate measurements because it relies on a single laser beam 105 that is returned by the SMR 110 to a sensor array within the laser tracker 100. Distance to the SMR 110 is calculated from the time of flight of one or more laser pulses. Vertical and horizontal displacement of the SMR 110 are measured when the returned laser beam shifts across the sensor array. Motors within the laser tracker 100 respond to directional changes in the returned beam by adjusting the direction of the outgoing beam so as to re-center the returned beam upon the sensor. Encoders measure the directional changes and transmit data to a software application that calculates target position in three spatial dimensions. Quick and highly accurate measurements of target position with respect to the laser tracker 100 are therefore possible without pre-defined spatial relationships between the target and tracker or resort to additional measuring devices.

The SMR 110 is a retroreflector mounted within a sphere, with a portion of the sphere removed to expose the retroreflector to a laser beam 105. Any suitable retroreflector may be used as a target. FIG. 2 shows a cross-sectional elevation view of an SMR 110 with an SMR housing 213 having a threaded shaft 215 that screws into a threaded opening 217 on one end of the probe bar 112, thereby securely mounting the SMR 110 in precise relation to the center of the probe bar 112. In this embodiment, the probe bar 112 is precision-machined to a 30 mm diameter.

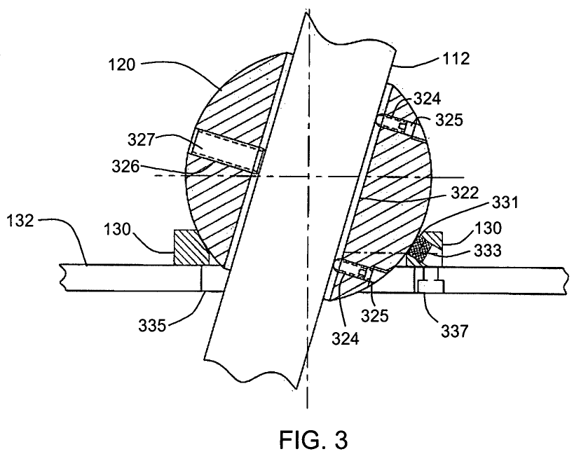

FIG. 3 shows an enlarged cross-sectional elevation view of the ball 120, center of the probe bar 112, circular bearing 130, and nearby supporting structures. In this embodiment, the ball is precision-machined to a 3-inch sphere. Other ball sizes may be preferred for larger or smaller embodiments of the invention. The probe bar 112 passes through a precision-drilled hole 322 in the center of the ball 120. In the embodiment of FIG. 3 the probe bar 112 is locked in position by two set screws 324 in threaded set screw holes 325 drilled into one side of the ball 120 and a set screw 327 threaded through a hole 326 drilled into the side of the ball 120 opposite from and parallel to the set screws 324. In alternate embodiments the probe bar 112 may be lock into position with a variety of means well-known in the art.

The ball 120 is pivotally supported by a circular bearing 130 of a diameter somewhat smaller than the diameter of the ball 120. An embodiment of the circular bearing 130 has a contact surface 331 machined to the same radius as that of the ball 120. The contact surface 331 may be a block 333 of low-friction material such as graphite, polytetrafluoroethylene, or other comparable material known in the art supported within the structure of the circular bearing 130. The circular bearing 130 may be mounted on a base plate 132 by machine screws 337 or other known fasteners. The ball 120 pivots freely within the circular bearing 130.

The probe bar 112 passes through the ball 120 and through a hole 335 in the base plate 132. Returning to FIG. 1, the base plate 132 is affixed by machine screws 134 or other fasteners known in the art to magnetic feet 136. The magnetic feet 136 allow rapid and secure installation of the base plate 132 above an opening in the inner surface 142 of a ferrous cylinder 140. In alternate embodiments, suction cups or other known attachments means may be used to quickly affix the base plate 132 to non-ferrous surfaces. A tooling ball 114 is mounted on the lower end of the probe bar 112 is the same fashion as the SWR 110 is mounted on the upper end.

In use, the base plate 132 is placed over an opening in a cylinder 140 with the lower portion 116 of the probe bar 112 protruding downward into the cylinder 140. The exposed upper portion 118 of the probe bar 112 is manually or mechanically displaced from an upright position until the tooling ball 114 contacts the inner surface 142 of the cylinder 140. The laser tracker 100 is positioned with a light of sight view of the SMR 110, acquires the SMR 110, measures the distance to the SMR 110, and begins to track its movements. With constant light outward radial pressure to keep the tooling ball 114 in contact with the inner surface 142 of the cylinder 140, the exposed end of the probe bar 112 is manually or mechanically moved so that the tooling ball 114 travels around part or all of the circumference of the inner surface 142.

The ball 120 pivots smoothly and precisely within the circular bearing 130. If the ball 120 is fixed to the center of the probe bar 112, the radial displacement of the SWR 110 will correspond exactly to the position of the tooling ball 114. The laser tracker 100 is therefore able to measure, record, and output the shape and size of the inner surface 142 along the path of the tooling ball 114.

However, the probe bar 112 may also be shifted within the ball 120 so that the upper portion 118 is longer or shorter than the lower portion 116. The laser tracker 100 may be programmed or manually operated to acquire both the position of the ball 120 and the SMR 110, then use the known length of the probe bar 112 and known dimensions of the SMR 110 and tooling ball 114 to calculate a scaling factor between the measured position of the SMR 110 and the position of the tooling ball 114. An operator may place a second SMR (not shown) of known dimensions upon the surface of the ball 120 and allow the laser tracker 100 to acquire the second SMR. Since the diameter of the ball 120 is known and the second SMR rests on the surface of the ball 120 on a radial line between the center of the ball 120 and the laser tracker, the position of the center of the ball 120 may be easily calculated by known programming or manual methods.

The measurement depth of the tooling ball 114 may therefore be easily changed by loosening set screws 327, 324, sliding the probe bar 112 up or down until the tooling ball 114 contacts the desired portion of the inner surface 142, locking the set screws 327, 324, reacquiring the positions of the ball 120 and the SMR 110, and proceeding with the measurement process described above. The measurement depth of the tooling ball 114 may be also adjusted with suitably-modified feet 136 or spacers.

Once the measurement is complete, the assembly may be immediately removed. Each step in this process is quickly and easily performed, allowing the present invention to provide an efficient means for making precision measurements of the inner dimensions of a cylinder during the manufacturing process, maintenance inspections, or at any other time.

The principles, embodiments, and modes of operation of embodiments of the invention have been set forth in the foregoing specification. The embodiments disclosed herein should be interpreted as illustrating the invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the invention.

I claim:

1. A measurement apparatus, comprising:
a base plate, the base plate having a base plate opening;
a bearing capable of supporting a ball, the bearing having a central opening, the central opening disposed above the base plate opening, the ball having a hole, the central axis of the hole passing through the center of the ball;
a bar, the bar having a first end and a second end, the bar passing through and fitting precisely within the hole; and
a laser target, the laser target mounted on the first end of the bar.

2. A measurement apparatus as claimed in claim 1, further comprising a tooling ball, the tooling ball mounted on the second end of the bar.

3. A measurement apparatus as claimed in claim 1, further comprising at least a pair of feet, the feet mounted beneath the base plate.

4. A system for measuring the interior contours of a hollow object, comprising:
a base plate, the base plate having a base plate opening;
a bearing capable of supporting a ball, the bearing having a central opening, the central opening disposed above the base plate opening, the ball having a hole, the central axis of the hole passing through the center of the ball;
a bar, the bar having a first end and a second end, the second end of the bar having a tip, the bar passing through and fitting precisely within the hole;
a laser target, the laser target mounted on the first end of the bar; and
a laser tracker, the laser tracker positioned to have a line of sight view of the laser target, the laser tracker operable to acquire the position of the laser target.

5. A system for measuring the interior contours of a hollow object as claimed in claim 4, further comprising a tooling ball, the tooling ball comprising the tip of the second end of the bar.

6. A system for measuring the interior contours of a hollow object as claimed in claim 4, further comprising at least a pair of feet, the feet mounted beneath the base plate and operable to mount the base plate upon an object to be measured.

7. A system for measuring the interior contours of a hollow object as claimed in claim 4, wherein the laser tracker is operable to compute the positions of the laser target and the tip.

8. A method for measuring the interior contours of a hollow object with an exterior opening, comprising the steps of:
mounting a base plate with a base plate opening upon the hollow object with the base plate opening disposed proximate to the exterior opening;
inserting a probe bar through a central hole in a ball and affixing the probe bar to the ball;
inserting a second end of the probe bar through a circular bearing surrounding the base plate opening, through the base plate opening, and into the interior of the hollow object;
resting the ball upon the circular bearing;
using a laser tracker to acquire the position of a first laser target mounted on a first end of the probe bar;
moving the first end of the probe bar so that ball pivots within the circular bearing and the second end of the probe bar contacts an interior surface of the hollow object;
moving the first end of the probe bar so that the second end of the probe bar moves across and remains in contact with the interior surface of the hollow object; and
using the laser tracker to track the position of the moving first laser target.

9. A method for measuring the interior contours of a hollow object with an exterior opening as claimed in claim 8, comprising the additional steps of placing a second laser target on the surface of the ball and acquiring the position of the ball with the laser tracker.

10. A method for measuring the interior contours of a hollow object with an exterior opening as claimed in claim 8, comprising the additional steps of using the laser tracker to calculate and output the interior contour of the hollow object along the path of the second end of the probe bar.

11. A method for measuring the interior contours of a hollow object with an exterior opening as claimed in claim 9, comprising the additional steps of using the laser tracker to calculate and output the interior contour of the hollow object along the path of the second end of the probe bar.

12. A method for measuring the interior contours of a hollow object with an exterior opening as claimed in claim 10, comprising the additional steps of using the laser tracker to calculate and output the interior contour of the hollow object along the path of the second end of the probe bar.
